(19) United States
(12) Patent Application Publication
(10) Pub. No.: US 2020/0305152 A1
(43) Pub. Date: Sep. 24, 2020

(54) USER EQUIPMENT AND SENSING CONTROL METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN)

(73) Assignee: NTT DOCOMO, INC., Tokyo (JP)

(21) Appl. No.: 16/088,734

(22) PCT Filed: Mar. 29, 2017
(86) PCT No.: PCT/JP2017/013073

§ 371 Date: Sep. 26, 2018

(30) Foreign Application Priority Data
Mar. 31, 2016 (JP) 2016-073453

(51) Int. Cl. H04W 72/04; H04W 72/02

(52) U.S. Cl. CPC H04W 72/0446; H04W 4/40; H04W 72/02

(57) ABSTRACT

A user equipment that selects resources for transmitting signals based on a sensing result includes: a sensing control unit that performs control so that sensing is not performed in a predetermined time region in a sensing time window; a resource selection unit that selects resources for transmitting signals among resources in a time region in which sensing is performed in the time window; and a transmission unit that transmits signals using the resources selected by the resource selection unit.

### TECHNICAL FIELD

The present invention relates to a technique of transmitting D2D signals in a mobile communication system that supports D2D.

### BACKGROUND ART

In LTE (Long Term Evolution) or LTE successor systems (for example, also referred to as LTE-A (LTE Advanced), 4G, FRA (Future Radio Access), or the like), a D2D (Device to Device) technique for allowing user equipments to perform direct communication without via a radio base station (eNB) has been discussed.

D2D reduces the traffic between UEs and eNB and enables communication to be performed between UEs and eNB even when the base station falls into an incommunicable state in the event of a disaster or the like.

D2D is broadly classified into D2D discovery and D2D communication (also referred to as D2D direct communication). In the following description, D2D communication and D2D discovery are referred to simply as D2D when both are not particularly distinguished from each other. Moreover, signals transmitted and received by D2D are referred to as D2D signals.

In 3GPP (3rd Generation Partnership Project), it is discussed to realize V2X by expanding the D2D function. As illustrated in FIG. 1, V2X is a part of ITS (Intelligent Transport Systems), and as illustrated in FIG. 1, is a generic term of V2V (Vehicle to Vehicle) meaning a form of communication performed between vehicles, V2I (Vehicle to Infrastructure) meaning a form of communication performed between a vehicle and a RSU (Road-Side Unit) provided on the roadside, V2N (Vehicle to Nomadic device) meaning a form of communication performed between a vehicle and a mobile terminal of a driver, and V2P (Vehicle to Pedestrian) meaning a form of communication performed between a vehicle and a mobile terminal of a pedestrian.

The V2X technique is based on the D2D technique defined in LTE. In the D2D technique, a method of allowing UE to select resources for transmitting D2D signals is broadly classified into a method of allocating resources dynamically from eNB and a method of allowing UE to select resources automatically. In V2X (particularly, V2V), since UEs (for example, vehicles) are present in high density and move at a high speed, it is not efficient to use the method of dynamically allocating resources and it is expected to use the method of allowing UEs to autonomously select resources.

In V2V, it is expected that, when UE selects resources autonomously, resources selected once are semi-persistently used rather than selecting resources whenever packets are transmitted. Moreover, when a problem (for example, collision) occurs in resources to be used, resources are reselected.

### CITATION LIST

### Non-Patent Document

Non-Patent Document 1: 3GPP TS 36.213 V12.4.0 (2014-12)

### SUMMARY OF THE INVENTION

### Problem to be Solved by the Invention

When a plurality of UEs selects (including reselects) transmission resources autonomously, if each UE selects resources freely, collision of resources may occur and a reception-side UE cannot receive signals appropriately.

Therefore, a sensing-based resource selection method in which resource sensing is performed to select resources which are not used (occupied) is proposed. For example, as illustrated in FIG. 2, a UE performs sensing in a sensing subframe indicated by A to select (or reselect) a time resource or a time and frequency resource which is not occupied to start transmitting D2D signals using the selected resource at the time point B.

However, in the above-described method, there is a problem that the UE has to stop transmission to perform sensing and latency increases. Moreover, there is a problem that another UE that tries to perform communication in a state in which a plurality of UEs selects resources to perform communication cannot select resources (that is, there is a lack of fairness in resource selection is defective).

Regarding that V2X is one kind of D2D, the above-mentioned problems can occur in general D2D without limiting to V2X.

The present invention has been made in view of the above-described circumstance, and an object thereof is to provide a technique capable of reducing latency and improving the fairness in resource selection in a method in which a user equipment selects resources for transmitting signals based on a sensing result.

### Means for Solving Problem

According to an embodiment of the present invention, there is provided a user equipment that selects resources for transmitting signals based on a sensing result, including: a sensing control unit that performs control so that sensing is not performed in a predetermined time region in a sensing time window; a resource selection unit that selects resources for transmitting signals among resources in a time region in which sensing is performed in the time window; and a transmission unit that transmits signals using the resources selected by the resource selection unit.

### Effect of the Invention

According to the disclosed technique, it is possible to provide a technique capable of reducing latency and improving the fairness in resource selection in a method in which a user equipment selects resources for transmitting signals based on a sensing result.

### BRIEF DESCRIPTION OF DRAWINGS

FIG. 1 is a diagram for describing V2X;

FIG. 2 is a diagram for describing problems;

FIG. 3A is a diagram for describing D2D;

FIG. 3B is a diagram for describing D2D;

FIG. 4 is a diagram for describing a MAC PDU used in D2D communication;

FIG. 5 is a diagram for describing the format of a SL-SCH subheader;

FIG. 6 is a diagram for describing an example of a channel structure used in D2D;

FIG. 7A is a diagram illustrating a structure example of PSDCH;

FIG. 7B is a diagram illustrating a structure example of PSDCH;

FIG. 8A is a diagram illustrating a structure example of PSCCH and PSSCH;

FIG. 8B is a diagram illustrating a structure example of PSCCH and PSSCH;

FIG. 9A is a diagram illustrating a resource pool configuration;

FIG. 9B is a diagram illustrating a resource pool configuration;

FIG. 10 is a diagram illustrating a configuration of a communication system according to the present embodiment;

FIG. 11 is a diagram for describing a transmission operation example;

FIG. 12 is a diagram for describing Operation example 1 according to the present embodiment;

FIG. 13 is a diagram for describing Operation example 2 according to the present embodiment;

FIG. 14 is a diagram for describing Operation example 2 according to the present embodiment;

FIG. 15 is a diagram for describing Operation example 3 according to the present embodiment;

FIG. 16 is a diagram for describing an operation example related to execution of sensing;

FIG. 17 is a diagram illustrating an example of a relation between a priority class and a resource occupancy ratio;

FIG. 18 is a diagram illustrating a configuration of a user equipment UE;

FIG. 19 is a diagram illustrating a hardware configuration of a user equipment UE;

FIG. 20 is a diagram illustrating a configuration of a base station eNB; and

FIG. 21 is a diagram illustrating a hardware configuration of a base station eNB.

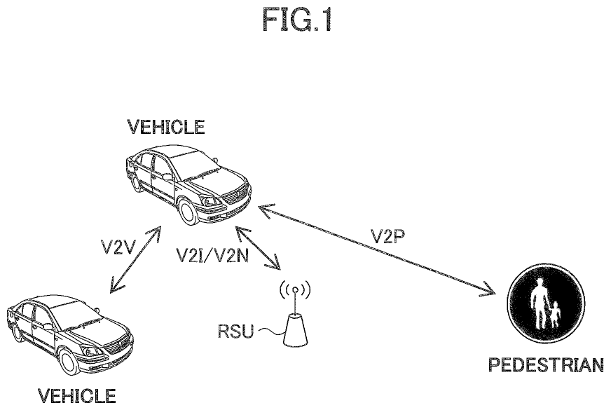

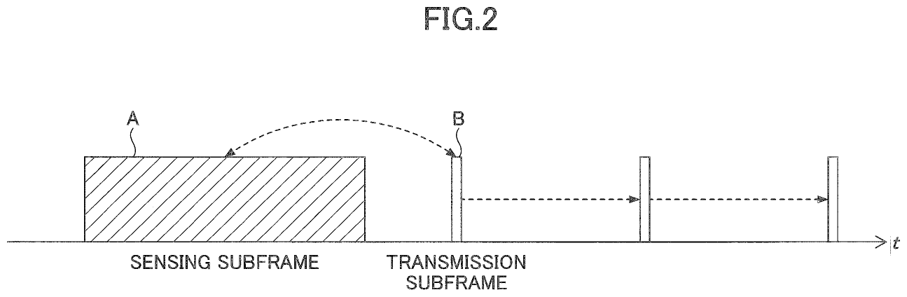

### MODE(S) FOR CARRYING OUT THE INVENTION

Hereinafter, an embodiment of the invention will be described with reference to the drawings. The embodiment to be described below is an example only, and an embodiment to which the invention is applied is not limited to the following embodiment. For example, although a mobile communication system according to the present embodiment is a system of a scheme compatible with LTE, the invention is not limited to LTE but can be applied to other schemes. In the present specification and the claims, “LTE” is used in a broad sense to include communication schemes (including 5G) corresponding to 3GPP release 12, 13, or later.

Although the present embodiment is mainly directed to V2X, the technique according to the present embodiment is not limited to V2X but can be broadly applied to general D2D. Moreover, “D2D” is meant to include V2X. The technique of the present embodiment can be applied to communication other than D2D.

In the following description, basically, a base station is denoted by “eNB” and a user equipment is denoted by “UE”. eNB is an abbreviation of “evolved Node B” and UE is an abbreviation of “User Equipment”.

(Overview of D2D)

The V2X technique according to the present embodiment is based on the D2D technique defined in LTE. Therefore, an overview of D2D defined in LTE will be described first. V2X can also use the D2D technique described herein, and the UE of the present embodiment can transmit and receive D2D signals according to the technique.

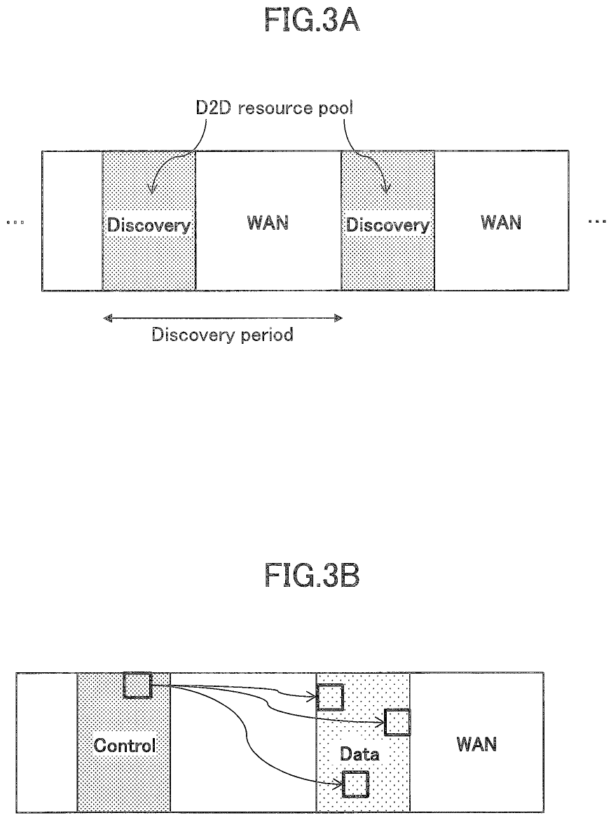

As described above, D2D is broadly classified into “Discovery” and “Communication”. As illustrated in FIG. 3A, in “Discovery,” a resource pool for discovery messages is secured for each discovery period and a UE transmits a discovery message in the resource pool. More specifically, the “Discovery” comes in Type 1 and Type 2b. In Type 1, a UE autonomously selects a transmission resource from a resource pool. In Type 2b, a semistatic resource is allocated by higher-layer signaling (for example, a RRC signal).

In “Communication,” Control/Data transmission resource pools are cyclically secured as illustrated in FIG. 3B. The cycle (period) is called a SC period (sidelink control period). A transmission-side UE notifies a data transmission resource or the like to the reception side using SCI (Sidelink Control Information) with the aid of a resource selected from a control resource pool (a SCI transmission resource pool) and transmits data with the aid of the data transmission resource. SCI indicating allocation of resources for data communication is referred to as SA (Scheduling Assignment). More specifically, the “Communication” comes in Mode 1 and Mode 2. In Mode 1, resources are dynamically allocated by (E)PDCCH transmitted from an eNB to a UE. In Mode 2, a UE autonomously selects a transmission resource from a resource pool. A resource pool notified using SIB or a predetermined resource pool is used as the resource pool.

In LTE, a channel used in “Discovery” is referred to as PSDCH (Physical Sidelink Discovery Channel), a channel used for transmitting control information such as SCI in “Communication” is referred to as PSCCH (Physical Sidelink Control Channel), and a channel used for transmitting data is referred to as PSSCH (Physical Sidelink Shared Channel) (for example, Non-Patent Document 1).

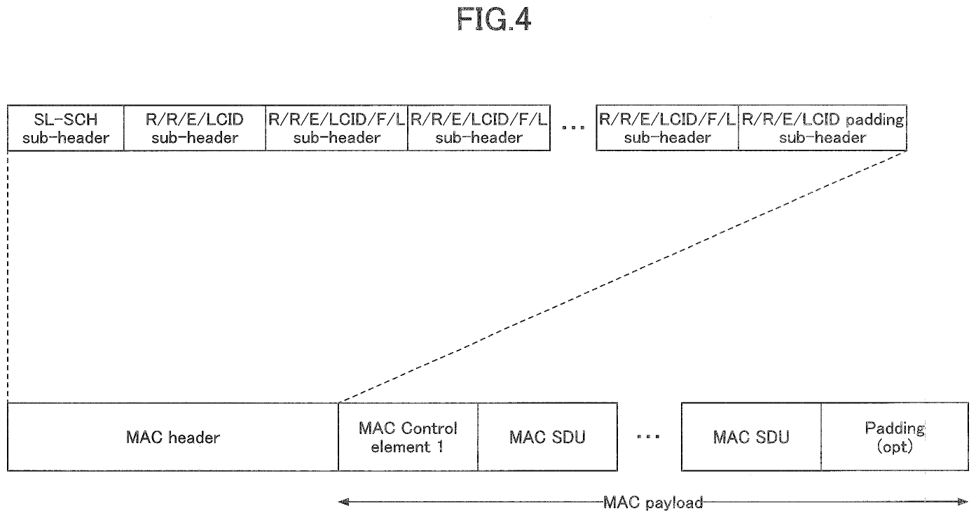

A MAC (Medium Access Control) PDU (Protocol Data Unit) used in D2D communication includes at least a MAC header, a MAC control element, a MAC SDU (Service Data Unit), and padding as illustrated in FIG. 4. The MAC PDU may include other information. The MAC header includes one SL-SCH (Sidelink Shared Channel) subheader and one or more MAC PDU subheaders.

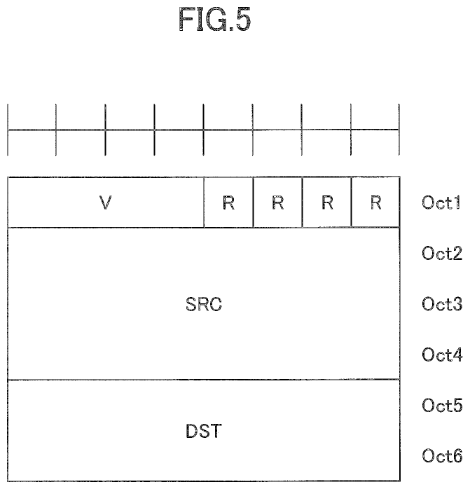

As illustrated in FIG. 5, the SL-SCH subheader includes a MAC PDU format version (V), transmission source information (SRC), transmission destination information (DST), a reserved bit (R), and the like. V is allocated to the start of the SL-SCH subheader and indicates a MAC PDU format version used by a UE. Information on a transmission source is set to the transmission source information. An identifier of a ProSe UE ID may be set to the transmission source information. Information on a transmission destination is set to the transmission destination information. Information on a ProSe Layer-2 Group ID of a transmission destination may be set to the transmission destination information.

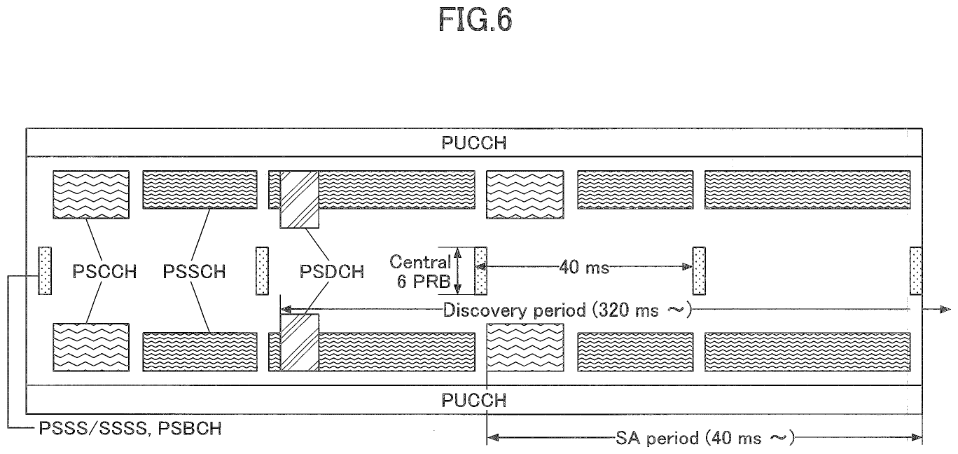

FIG. 6 illustrates an example of a channel structure of D2D. As illustrated in FIG. 6, a PSCCH resource pool and a PSSCH resource pool to be used for Communication are allocated. Moreover, a PSDCH resource pool to be used for Discovery is allocated at a cycle longer than the cycle of the channel of Communication.

PSSS (Primary Sidelink Synchronization signal) and SSSS (Secondary Sidelink Synchronization signal) are used as a D2D synchronization signal. Moreover, PSBCH (Physical Sidelink Broadcast Channel) in which notification information (broadcast information) such as a system band of D2D, a frame number, or system configuration information, is transmitted is used for out-of-coverage operations, for example.

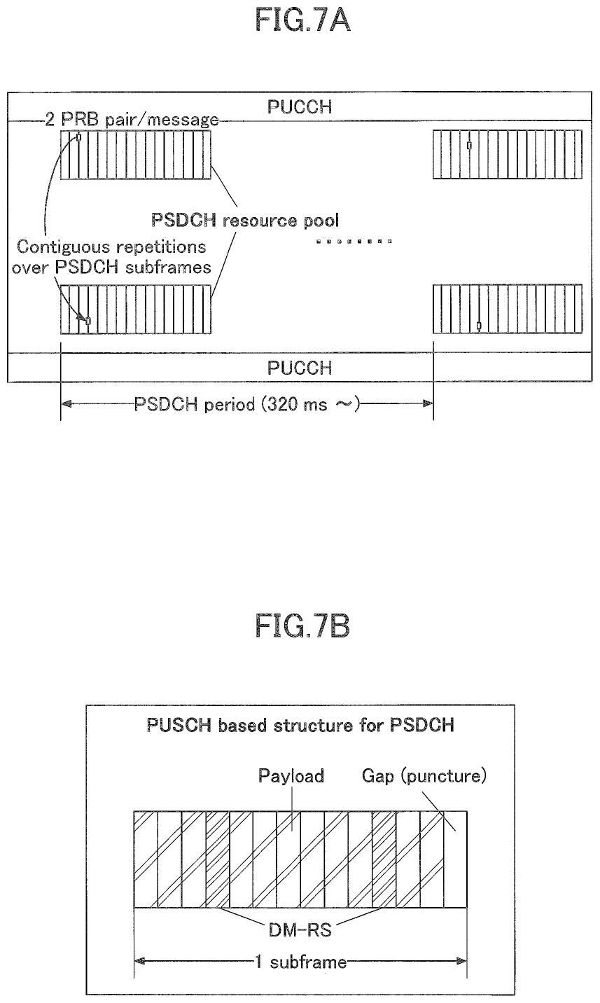

FIG. 7A illustrates an example of a PSDCH resource pool used for “Discovery”. Since a resource pool is set by a bitmap of a subframe, the resource pool is represented by such an image as illustrated in FIG. 7A. The same is true to the resource pool of the other channel. Moreover, PSDCH is repeatedly transmitted (repetition) using frequency hopping. The number of repetitions can be set to 0 to 4, for example. Moreover, as illustrated in FIG. 7B, PSDCH has a PUSCH-based structure and has a structure in which a DMRS (demodulation reference signal) is inserted.

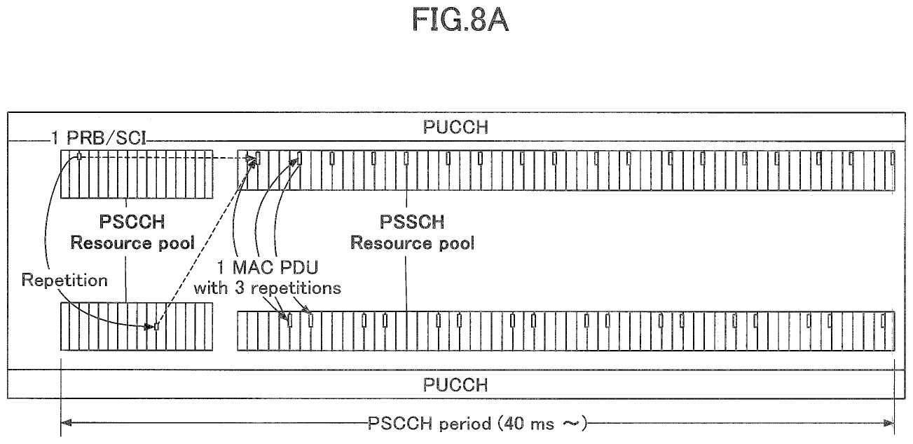

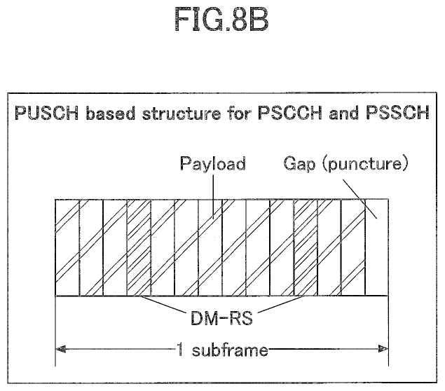

FIG. 8A illustrates an example of PSCCH and PSSCH resource pools to be used for “Communication”. As illustrated in FIG. 8A, PSCCH is repeatedly transmitted (repetition) one time using frequency hopping. PSSCH is repeatedly transmitted (repetition) three times using frequency hopping. As illustrated in FIG. 8B, PSCCH and PSSCH have a PUSCH-based structure and has a structure in which DMRS is inserted.

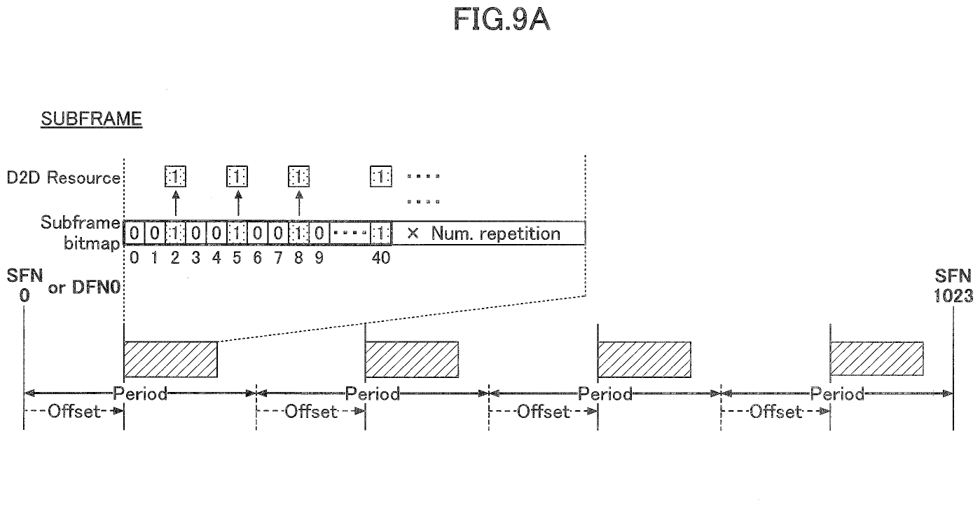

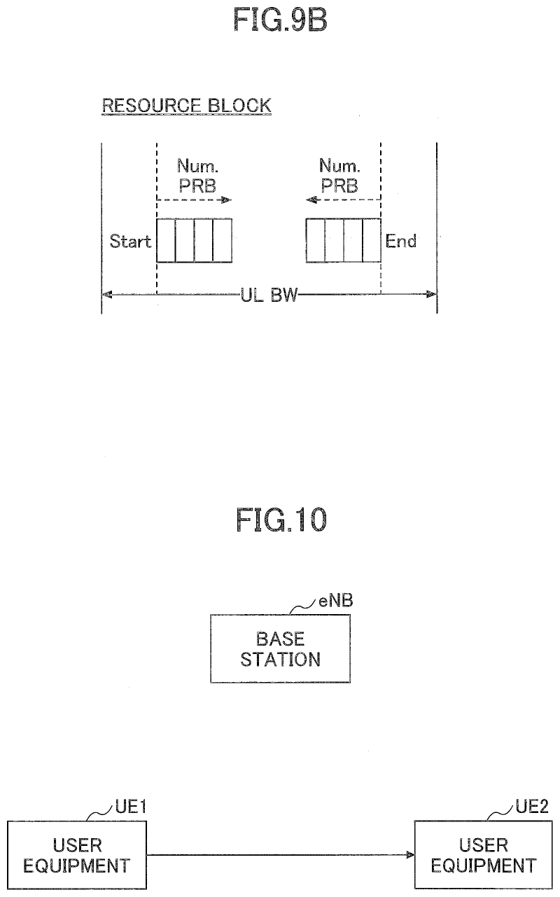

FIGS. 9A and 9B illustrate an example of a resource pool configuration of PSCCH, PSDCH, and PSSCH (Mode 2). As illustrated in FIG. 9A, a resource pool is represented as a subframe bitmap in the time direction. Moreover, the bitmap is repeated by the number of num.repetition. Moreover, an offset indicating the starting position of each cycle is designated.

In the frequency direction, continuous allocation (contiguous) and discontinuous allocation (non-contiguous) are possible. FIG. 9B illustrates an example of discontinuous allocation, and as illustrated in FIG. 9B, starting PRB, ending PRB, and the number of PRBs (numPRB) are designated.

While the overview of D2D has been described, the channels used in the D2D may be used for transmitting and receiving signals in the operation examples of the present embodiment to be described later and newly defined channels may be used.

(System Configuration)

FIG. 10 illustrates a configuration example of a communication system according to the present embodiment. As illustrated in FIG. 10, the communication system includes eNB, UE1, and UE2. In FIG. 10, although UE1 is depicted as a transmission side and UE2 is depicted as a reception side, UE1 and UE2 have both transmission and reception functions. In the following description, the operation of UE1 on the transmission side will be described mainly. Moreover, the UE1 will be described simply as UE. The eNB notifies setting of a resource pool and various items of configuration information to the respective UEs, for example. However, communication of data or the like between UEs in the present embodiment can be performed without via the eNB.

The UEs of the present embodiment each have a cellular communication function of a UE in LTE and a D2D function including transmission and reception of signals in the above-described channel. Moreover, the UEs have a function of executing operations to be described in the present embodiment. The UEs may have all or some of the cellular communication function and the existing D2D function (within a range in which the operations to be described in the present embodiment can be executed).

Although the UEs may be arbitrary devices that perform V2X, and the UEs may be terminals, RSUs, or the like provided in or held by vehicles or pedestrians.

The eNB has a cellular communication function as an eNB in LTE and a function (a sensing resource pool allocation function or the like) for enabling communication of UEs in the present embodiment.

Hereinafter, the operation example according to the present embodiment will be described. However, the “D2D signal” in the operation example may be any one of SA and data in “Communication” and a discovery signal in “Discovery” unless stated otherwise particularly. In the following example, although it is assumed that a UE performs an operation of selecting one or a plurality of subframes first to transmit D2D signals and selecting a time resource or a time and frequency resource to be actually used for transmission among the resources of the subframe, such an operation is an example. For example, the time resource or the time and frequency resource may be selected first based on a sensing result.

(Basic Operation)

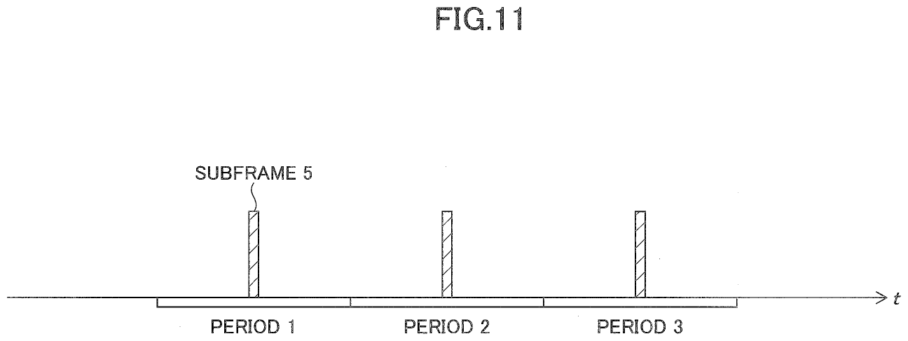

In the present embodiment, basically, a UE selects a time resource (for example, a subframe) or a time and frequency resource for transmission based on sensing from transmission resource pools set from an eNB, for example, and transmits D2D signals cyclically semi-persistently using the time resource or the time and frequency resource unless reselection is performed. As an example, in the example illustrated in FIG. 11, periods 1 to 3 are illustrated among a plurality of periods which arrives cyclically, and the UE performs sensing at a stage before period 1. Moreover, for example, when it is detected that subframe 5 is a subframe in which the occupancy ratio by another UE is low, D2D signals are transmitted using subframe 5 in each of periods 1, 2, and 3. The cycle at which cyclic transmission is performed is set from an eNB to a UE via a notification signal (broadcast information such as SIB or the like), UE specific signaling (RRC signaling or the like), and the like, for example. Moreover, such a cycle may be pre-configured in the UE and the UE may autonomously select the cycle.

The D2D signal may be SA, data, and a set of SA and data. The D2D signal may be a discovery signal.

According to an example of a sensing method performed by the UE in the present embodiment, the UE measures a reception power level (may be referred to as reception energy or reception intensity) in one or a plurality of subframes in which sensing is performed, selects a time resource or a time and frequency resource in which the reception power level is low, and uses the selected time resource or time and frequency resource for transmission in a subsequent timing which arrives cyclically. According to another example of the sensing method, the UE receives SA transmitted from other UEs in one or a plurality of subframes in which sensing is performed, decodes the SA to detect the resource location of the allocated SA and data, selects a time resource or a time and frequency resource in which the resource occupancy ratio is low or which is not occupied, and uses the selected time resource or time and frequency resource for transmission in a subsequent timing which arrives cyclically. According to still another example of the sensing method, the UE receives data from other UEs and decodes the received data to thereby select a time resource or a time and frequency resource in which the operation state is low or which is not occupied. Moreover, these methods may be used in combination.

When the value used as a semistatic packet transmission cycle is limited (for example, a SPS transmission cycle is defined as a fixed value), the UE may transmit packets at an effectively short period using a plurality of SPS transmission processes. For example, when a transmission cycle of 500 ms is defined, transmission at the cycle of 100 ms can be realized using 5-process SPS transmission which uses offsets of 0, 100 ms, 200 ms, 300 ms, and 400 ms. In this way, a reception terminal can perform a sensing operation assuming a predetermined packet transmission cycle and the sensing process is simplified. Moreover, the UE may notify a data transmission cycle in the content of SA. That is, the UE may transmit SA by inserting the data transmission cycle in the SA. Here, the data transmission cycle is the above-mentioned effective cycle.

Hereinafter, operation examples of the UE according to the present embodiment will be described. Operation examples 1 to 3 to be described below enable a UE to perform sensing in a limited subframe to reduce latency and improve fairness.

### Operation Example 1

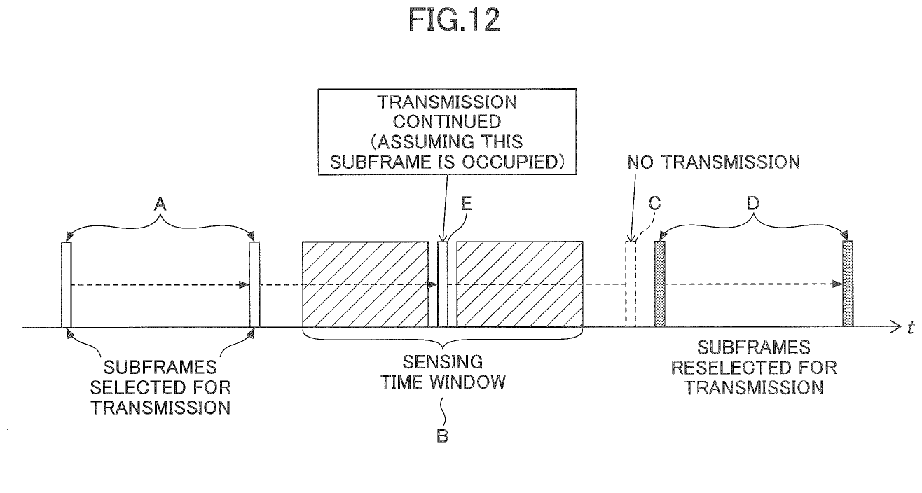

Operation example 1 of UE will be described with reference to FIG. 12. In Operation example 1, as indicated by B, a time window (a sensing time window) in which a UE performs sensing is defined.

The sensing time window arrives cyclically, for example, and the length, the cycle, and the like are set from an eNB to a UE via a notification signal (broadcast information such as SIB or the like), individual signaling (RRC signaling), or the like. That is, the UE receives configuration information for setting from the eNB. Moreover, the sensing time window may be pre-configured and a fixed value may be used in order to simplify a sensing operation. For example, the sensing cycle (the arrival cycle of sensing time windows) may be the same as (equal to) a semistatic packet transmission cycle (SPS cycle). Moreover, the sensing cycle (the arrival cycle of sensing time windows) may be M multiples (M is an integer of 1 or more) of the semistatic packet transmission cycle (SPS cycle).

Basically, the UE performs sensing in each subframe (sensing subframe) in the sensing time window to select a time resource or a time and frequency resource which is not occupied by other UEs.

However, in Operation example 1, when D2D signals are cyclically transmitted, the transmission is continued in the sensing time window without stopping the cyclic transmission. The continued transmission is not limited to cyclic transmission.

In the example illustrated in FIG. 12, as indicated by A, the UE cyclically transmits D2D signals. In the sensing time window, the cyclic D2D signal transmission is performed in a subframe indicated by E. Sensing is not performed in the subframe. In Operation example 1, sensing is not performed in both subframes (or a plurality of symbols) adjacent to the subframe in which the transmission is performed in order to switch transceivers. However, it is not essential that sensing is not performed in both subframes (or a plurality of symbols), but sensing may be performed in the subframes.

As for a subframe in which sensing is not performed (sensing is skipped) in the sensing time window, the UE assumes that resources are occupied and eliminates the subframe from a selection candidate for the time resource or the time and frequency resource for transmitting D2D signals. That is, the subframe in which sensing is not performed (sensing is skipped) is not used as a transmission resource in a subsequent cycle. Moreover, the subframe is not used as the resource for transmitting D2D signals in subsequent cycles as long as sensing is not performed in the subframe.

In the example of FIG. 12, transmission is performed in subframes indicated by E and C if cyclic transmission indicated by A is continued without the sensing time window. However, as illustrated in FIG. 12, since sensing is not performed in the subframe indicated by E in the sensing time window, it is assumed that the subframe is occupied by other UEs and transmission is not performed in the subframe indicated by C. That is, in Operation example 1, when transmission is performed at the cycle of N subframes (N is 1 or more), for example, it is assumed that a subframe which is N subframes later than a subframe in which sensing for transmission is skipped in the sensing time window is occupied and the subframe is not selected for transmission.

On the other hand, in the sensing time window indicated by B in FIG. 12, sensing is performed in subframes in the sensing time window other than the subframe in which sensing is skipped. In the example of FIG. 12, a subframe is reselected based on a sensing result, and D2D signals are transmitted in cyclic subframes indicated by D.

As described above, in Operation example 1, since the UE transmits a D2D signal in the sensing time window, it is possible to eliminate latency resulting from sensing. Moreover, in Operation example 1, since the UE reselects transmission resources everytime after performing sensing, it is possible to cope with a change in a traffic pattern. Furthermore, in Operation example 1, a same UE is prevented from continuously using the same resource, which contributes to improving the fairness between UEs. Furthermore, since a time region in which sensing is not performed is provided in the sensing time window, it is possible to save battery power.

### Operation Example 2

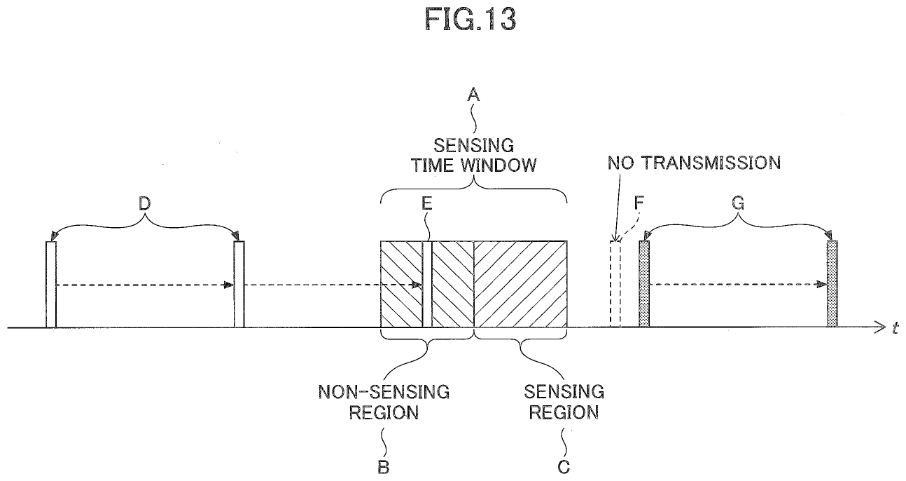

Next, Operation example 2 will be described with reference to FIG. 13. In Operation example 2, a sensing time window is set as illustrated in FIG. 13. Similarly to Operation example 1, the sensing time window arrives cyclically, for example, and the length, the cycle, and the like are set from an eNB to a UE via a notification signal (broadcast information such as SIB or the like), individual signaling (RRC signaling), or the like, for example. Moreover, the sensing time window may be pre-configured.

Basically, the UE performs sensing in each subframe (sensing subframe) in the sensing time window to select a time resource or a time and frequency resource which is not occupied by other UEs.

However, in Operation example 2, a non-sensing region is set in the sensing time window. The UE does not perform sensing in a non-sensing region (for example, a time region made up of one or a plurality of subframes) in the sensing time window. In the example of FIG. 13, the UE does not perform sensing in a non-sensing region indicated by B within a sensing time window indicated by A and performs sensing in a sensing region (for example, a time region made up of one or a plurality of subframes) indicated by C.

The UE can perform transmission in a non-sensing region. FIG. 13 illustrates an example corresponding to this case. That is, as indicated by D, the UE transmits D2D signals cyclically. Moreover, the UE performs the cyclic D2D signal transmission in a subframe indicated by E in the non-sensing region in the sensing time window.

In this case, in Operation example 2, the UE assumes that resources later than cycles subsequent to the non-sensing region in which sensing is not performed are occupied and does not select transmission resources from the non-sensing region. For example, when transmission is performed at the cycle of N subframes (N is 1 or more), assuming that the resources of a subframe which is N subframes later than the subframe in which sensing is skipped in the non-sensing region in the sensing time window are occupied, the UE does not select the resources for transmission. FIG. 13 illustrates that transmission indicated by F corresponding to the transmission subsequent to the cyclic transmissions indicated by D and E is not performed as an example of such a case. The transmission indicated by G indicates transmission which uses the resource selected based on sensing in the sensing region.

Rather than assuming that the resources of a subframe at the next cycle (which is N subframes later than) of the non-sensing region are occupied as described above, transmission in the non-sensing region may not be performed by assuming that the non-sensing region itself is occupied. In this case, the transmission indicated by E in FIG. 13 is not performed.

The sensing region and/or the non-sensing region in the sensing time window is set (configured) from an eNB (network) to a UE, for example. The setting is performed via a notification signal (broadcast information such as SIB or the like), individual signaling (RRC signaling or the like), and the like. When the setting is notified commonly to UEs via a broadcast signal or the like, the sensing and non-sensing regions may be common between UEs and traffic may concentrate on a specific subframe. Therefore, a time offset may be applied to regions based on terminal information such as UE-ID, and the time width (the number of subframes) of the sensing region and/or the non-sensing region only may be notified so that the UE can arbitrarily select the time offset.

The UE may autonomously select the sensing region and the non-sensing region in the sensing time window. For example, a UE which is not connected to an eNB may autonomously select the regions in this manner. Although an autonomous selection method is not particularly limited, the UE may select the regions based on the UE-ID or the position information of UE.

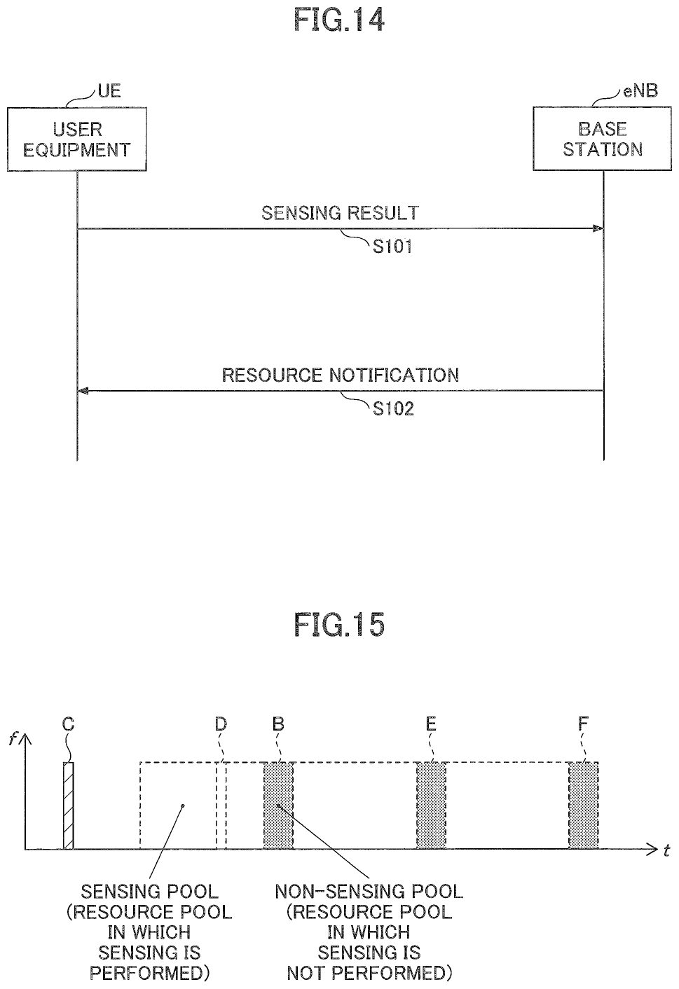

The UE may report a desired sensing region, a desired non-sensing region, and/or a sensing result to the eNB. For example, as illustrated in FIG. 14, the UE reports a sensing result obtained by performing sensing in a sensing region to the eNB (step S101). The sensing result includes information on a sensing region (for example, one or a plurality of subframes) and a resource occupancy ratio in each subframe, for example. As an example, the resource occupancy ratio is the percentage of a time and frequency resource allocated to data transmission among all time and frequency resources of a certain subframe when allocation of data transmission of other UEs is ascertained by SA.

The eNB having received the sensing result can allocate resources (including allocation of D2D resources, allocation of resource for cellular communication between UE and eNB) to UEs by taking the sensing result into consideration. For example, according to the sensing result, it is possible to perform control to allocate subframes other than the subframe having a high occupancy ratio. Moreover, the eNB sends a resource notification (for example, notification via PDCCH) in step S102.

In Operation example 2, the UE can eliminate latency resulting from sensing by shortening the sensing time. Moreover, in Operation example 2, a same UE is prevented from continuously using the same resource, which contributes to improving the fairness between UEs. Furthermore, since a time region in which sensing is not performed is provided in the sensing time window, it is possible to save battery power.

### Operation Example 3

Next, Operation example 3 will be described with reference to FIG. 15. In Operation example 3, a sensing pool which is a resource pool for sensing and a non-sensing pool which is a resource pool in which sensing is not performed are set from an eNB to a UE. That is, configuration information is transmitted from an eNB to a UE. These resource pools are set from an eNB to a UE via a notification signal (broadcast information such as SIB or the like), individual signaling (RRC signaling or the like), and the like. Moreover, these resource pools may be pre-configured. Each resource pool may be represented by a subframe number or a subframe number and a frequency resource location, and the like, and may be represented by the method described with reference to FIGS. 9A and 9B.

The non-sensing pool set in Operation example 3 is set together with the sensing pool and is a fallback resource for transmission. As an example, when the need to transmit D2D signals occurs in a state in which a UE performs sensing using the resources of a sensing pool illustrated in FIG. 15, D2D signals are transmitted using the resources of the non-sensing pool indicated by B.

As a more detailed example, in a state in which cyclic transmission indicated by C is performed, when the timing of the cyclic transmission occurs in a sensing pool indicated by D, for example, the UE performs transmission using resources of a non-sensing pool (the non-sensing pool indicated by B in the example of FIG. 15) in which the first subframe is closest to the transmission subframe (the subframe indicated by D) among the non-sensing pools (three non-sensing pools indicated by B, E, and F in FIG. 15). A UE that does not have a function of performing sensing can perform transmission using the non-sensing pool.

The sensing pool and the non-sensing pool may be mapped in a manner of 1 to N correspondence (N is an integer of 1 or more), and the non-sensing pool may not be correlated to any sensing pool.

As an example, when 1 to 2 mapping is applied, the eNB notifies information such as “Sensing pool 1, Non-sensing pool A1, and Non-sensing pool B1” and “Sensing pool 2, Non-sensing pool A2, and Non-sensing pool B2” to the UE via a notification signal, individual signaling, or the like to perform configuration. When the need to perform transmission occurs in a state in which sensing is performed in Sensing pool 1, for example, the UE performs transmission using Non-sensing pool A1 or Non-sensing pool B1.

When the non-sensing pool is not associated with any sensing pool, the eNB notifies information such as “Sensing pool 1 and Sensing pool 2,” and “Non-sensing pool A, Non-sensing pool B, and Non-sensing pool C” to the UE via a broadcast signal, individual signaling, or the like to perform configuration. In this case, when the need to perform transmission occurs in a state in which sensing is performed in Sensing pool 1 or Sensing pool 2, the UE selects one pool from the three non-sensing pools of Non-sensing pool A, Non-sensing pool B, and Non-sensing pool C and performs transmission.

### Operation Example 4

Next, Operation example 4 will be described. In this operation example, the sensing time window described in Operation examples 1 and 2 is set to respective resource pools. The resource pool is a pool of resources to be used for transmitting D2D signals, for example. When a plurality of resource pools is set to a UE, the UE can select a resource pool suitable for a packet transmission cycle among the plurality of resource pools. Moreover, the eNB may configure the resource pool based on a request from the UE. For example, when configuration of the resource pool is performed from the eNB to the UE, the eNB notifies configuration information such as “Resource pool 1 and Sensing time window 1” and “Resource pool 2 and Sensing time window 2,” for example, to the UE. For example, “Resource pool 1 and Sensing time window 1” indicates that Sensing time window 1 is set to Resource pool 1.

As an example of reduction in latency resulting from sensing, similarly to Operation example 3, when a UE performs sensing in a certain resource pool, a resource pool in which a shorter sensing time window is set is temporarily selected. In this example, although fallback to a resource pool in which short sensing is permitted is performed temporarily and sensing is still required, an effect of reducing the sensing time is obtained. The UE may autonomously select such a fallback resource pool and the eNB may set the fallback resource pool to the UE based on a request from the UE. Moreover, the eNB may set a fallback resource pool to the UE in advance and a fallback resource pool may be pre-configured to the UE.

(Notification of UE Capability)

The function of allowing a UE to perform sensing to select resources may not be implemented on all UEs.

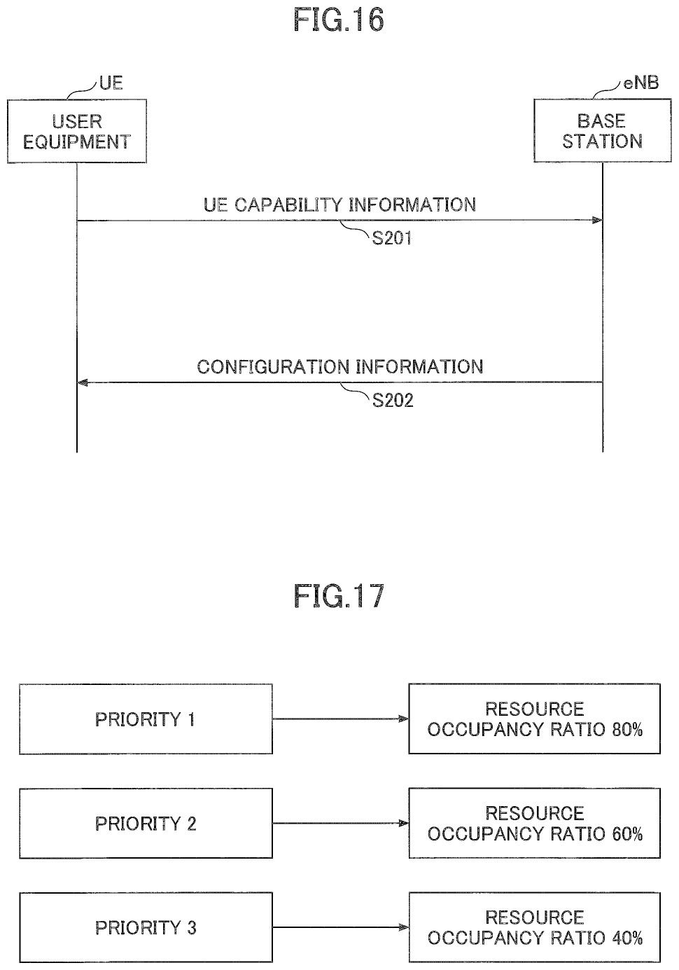

Therefore, in the present embodiment, as illustrated in FIG. 16, when a UE has a function of performing sensing-based resource selection, the UE transmits capability information (UE Capability) indicating that the UE has a function of performing sensing-based resource selection to the eNB (step S201). The eNB can transmit configuration information (for example, various items of configuration information described in Operation examples 1 to 4) to the UE which is confirmed to have the capability (step S202). Moreover, the eNB may transmit instruction information to the UE to perform a sensing-based operation together with the configuration information. Moreover, the eNB may send the configuration information to all UEs via notification information and may send instruction information to the UE having the capability to perform the sensing-based operation to perform the sensing-based operation. Whether the sensing operation can be performed in the background may be set from the eNB to the UE.

The communication priority class of the UE may be reported to the eNB to send instruction information to individual UEs to allow the eNB to perform a sensing-based operation or not according to the priority class. Alternatively, the UE may autonomously recognize whether or not to perform a sensing-based operation and a selectable resource pool according to the communication priority class thereof and the terminal capability.

The UE may report a subframe in which sensing is performed and a sensing operation (reception power level measurement, SA monitoring, or the like) to the eNB. Particularly, in Operation example 2, when the UE autonomously selects a non-sensing region or a sensing region, by notifying a subframe in which sensing is performed in this manner to the eNB, the eNB can understand which subframe was selected as the non-sensing region or the sensing region by the UE. The eNB having received such a report can perform scheduling in the non-sensing region for the UE when the reception capability of the UE is limited, for example.

A case in which a subframe to be used for sensing is allocated for transmission or reception of DL (arbitrary carrier) or UL (the same carrier as D2D) in cellular communication of UEs will be considered. In this case, when the UE does not support a simultaneous operation of UL/DL and sensing, the UE skips sensing in the subframe, for example. In this example, although the cellular communication is prioritized, when a simultaneous operation of UL/DL and sensing is not supported, which one will be prioritized may be configured from the eNB to the UE.

In Operation examples 3 and 4, the UE can eliminate latency resulting from sensing by performing transmission in the non-sensing region (in Operation example 4, the region other than the sensing time window). Moreover, in Operation examples 3 and 4, for example, when sensing is performed in the sensing region, for example, resources are reselected, whereby the same UEs are prevented from continuously using the same resource, which contributes to improving the fairness between UEs. Furthermore, since the non-sensing region is provided, it is possible to save battery power.

### Operation Example of Resource Selection/Reselection

Next, an operation example of resource selection/reselection will be described. The content to be described below can be also applied to any one of Operation examples 1 to 4.

In the present embodiment, a threshold indicating a “largest resource occupancy ratio” is used as a reference for a UE to select a transmission resource (for example, a subframe or a time and frequency resource). The threshold is configured from the eNB to the UE via a notification signal (SIB or the like), individual signaling (RRC signaling or the like), or the like. Moreover, the threshold may be pre-configured.

The UE performs sensing in a certain resource range determines whether the resource occupancy ratio in the resource range exceeds a threshold. When the threshold exceeds the threshold, the UE determines that the resource range is occupied by other UEs and does not select/reselect a transmission resource from the resource range. The resource range is one or a plurality of subframes, for example. Moreover, the resource range may be a time and frequency resource range.

When the UE recognizes the occupying resource based on a decoding result of control information such as SA, a subframe having the largest number of vacant resources may be selected among subframes in which available transmission resources are present. In this way, it is possible to avoid the effect of in-band emission.

The resource occupancy ratio can be defined as the percentage of resources allocated for data transmission in a predetermined resource range (for example, a subframe, a time and frequency resource, or the like) by decoding received SA (or by decoding received data itself), for example.

The UE may determine a sensing target resource range (for example, a subframe, a time and frequency resource, or the like) is occupied when the average of the reception power level in the resource range is equal to or larger than a threshold.

The threshold indicating the largest resource occupancy ratio may be set to the UE in a form of being correlated with the priority class of the UE or the priority class of a transmission packet. FIG. 17 illustrates an example of correlation between a priority class and a threshold. In the example illustrated in FIG. 17, the corresponding priority class and the threshold are listed from top to bottom in descending order of priority classes. For example, a threshold of 60% is used for a UE (or a packet) of which the priority class is 2. The priority class of a UE will be described as an example. For example, upon detecting that the occupancy ratio of a sensing target resource range exceeds the threshold of 60%, the UE having the priority class of 2 does not select the resources in the resource range as transmission resources. The priority class of a packet will be described as an example. For example, when a UE transmits a packet having the priority class of 2, upon detecting that the occupancy ratio of a sensing target resource range exceeds the threshold of 60%, the UE does not select resources in the resource range as transmission resources for the packet.

As described above, when resources are selected using a threshold and a network is heavily congested, since a UE cannot decode SA, there is a possibility that it is determined that occupied resources are not occupied.

Therefore, in the present embodiment, the UE also determines a reception power level (reception energy) as well as determining the occupancy ratio by decoding SA.

Specifically, when the UE detects that the reception power level in a certain resource range (for example, a subframe or a certain subband in a certain subframe) exceeds a threshold in the course of performing sensing, the UE determines that the resource range is occupied. The threshold is configured from the eNB to the UE via a notification signal (SIB or the like), individual signaling (DCI/MAC/RRC signaling or the like), or the like. Moreover, the threshold may be pre-configured. Moreover, as described above, the threshold may be set for each priority class (the priority class of a UE or a packet).

Upon detecting that the reception power level in a certain resource range exceeds a threshold based on sensing, the UE may report the event (an overload event) to the eNB. In this way, the eNB can perform transmission speed control or the like, for example.

The UE may select a subframe in which the number of resource blocks occupied by other UEs is the smallest among a plurality of subframes in a certain resource pool (for example, a sensing pool).

A reselection probability, cycle, subframe backoff, or the like may be configured to a UE for each priority class of the UE or each priority class of the packet. This configuration is performed from the eNB to the UE via a notification signal (SIB or the like), individual signaling (RRC signaling or the like), or the like.

For example, a reselection probability per subframe or a reselection probability per set cycle (periodicity) is set. When a reselection probability per cycle is set and reselection is performed, the UE randomly select resources at the set reselection cycle. Moreover, the reselection probability, cycle, subframe backoff, or the like may depend on the resource occupancy ratio. As an example, a UE having a low priority class may be configured to perform reselection frequently (at short cycles).

(Device Configuration)

<UE>

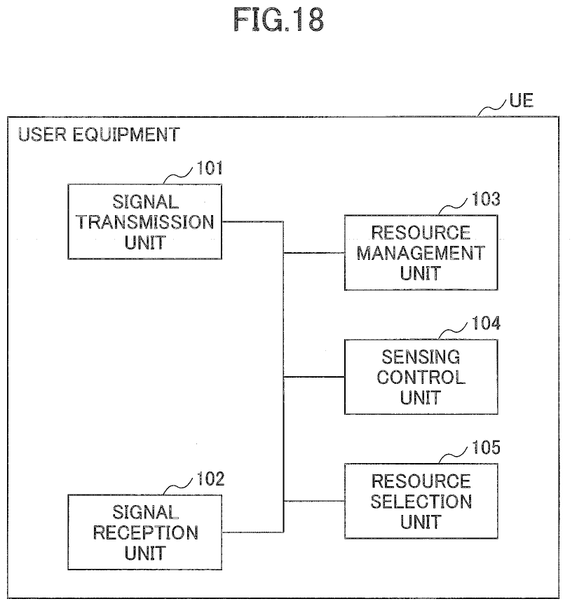

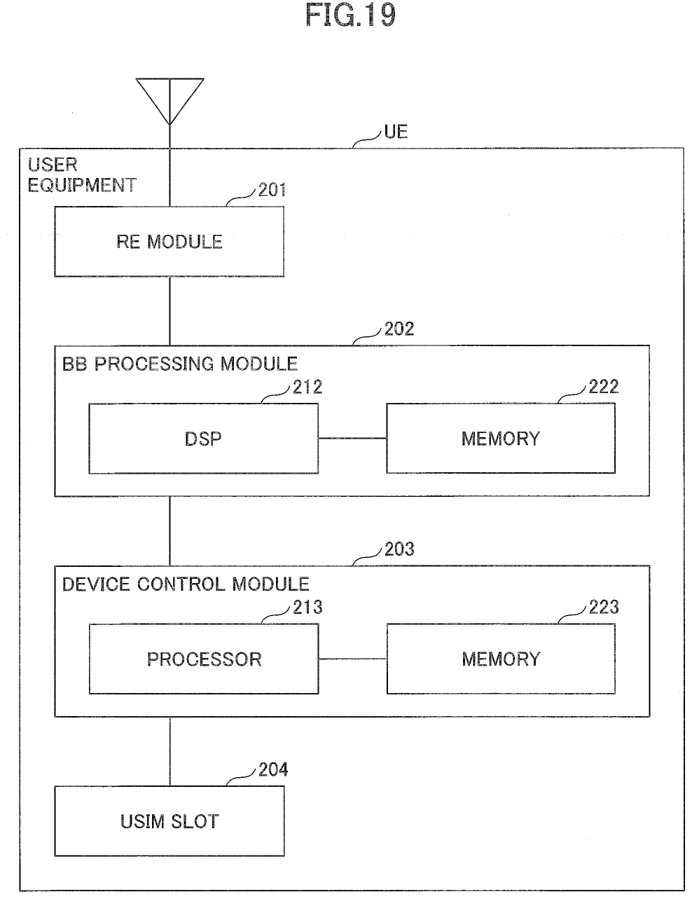

FIG. 18 illustrates a functional configuration of a UE according to the present embodiment. The UE illustrated in FIG. 18 can execute all processes of the UE described above. The UE may be executable some (for example, the operations of one or two operation examples of Operation examples 1 to 4) of the processes of the UE described above.

As illustrated in FIG. 18, the UE includes a signal transmission unit 101, a signal reception unit 102, a resource management unit 103, a sensing control unit 104, and a resource selection unit 105. FIG. 18 illustrates functional units of the UE particularly related to the embodiment only and also includes at least functions (not illustrated) for performing operations compatible with LTE. Moreover, the functional configurations illustrated in FIG. 18 are examples only. The functional classifications and the names of the functional units are not particularly limited as long as the operations of the UE according to the present embodiment can be executed. Moreover, the UE is a device which may be any device that forms V2X when the UE is applied to V2X. For example, the UE may be a vehicle, a RSU, a terminal held by a pedestrian, or the like.

The signal transmission unit 101 includes a function of mapping signals (for example, bits, symbols converted from bits, or the like) to be transmitted from the UE onto resources to generate radio signals, and transmitting the radio signals wirelessly. Moreover, the signal transmission unit 101 has a D2D (including V2X) signal transmission function and a cellular communication transmission function. A D2D transmission scheme may be any one of SC-FDMA, OFDM, and OFDMA. Moreover, another transmission scheme other than these schemes may be used. Moreover, the signal transmission unit 101 transmits signals using the resources selected by the resource selection unit 105. Furthermore, as described above, the signal transmission unit 101 may transmit data at an effectively short cycle using a plurality of SPS transmission processes. Moreover, the signal transmission unit 101 may transmit SA by inserting a data transmission cycle in the SA.

The signal reception unit 102 includes a function of wirelessly receiving various signals from the other UE, the eNB, and the like and acquiring higher-layer signals from the received physical layer signals. The signal reception unit 102 has a D2D (including V2X) signal receiving function and a cellular communication receiving function. Moreover, the signal reception unit 102 receives configuration information of a sensing pool which is a pool of resources in which sensing is performed and configuration information of a non-sensing pool which is a pool of resources in which sensing is not performed from the eNB. The signal reception unit 102 receives the configuration information of the resource pool of Operation example 4 from the eNB.

The resource management unit 103 maintains information on a resource pool to be used for the UE to transmit and receive D2D signals and information (for example, a sensing time window, a sensing region, a non-sensing region, a sensing pool, a non-sensing pool, and the like) on resources related to sensing. These items of information may be set from other device such as an eNB and may be set autonomously by the UE itself. The resource information maintained in the resource management unit 103 is referenced from other functional units and is used for the operation of the other functional units.

The sensing control unit 104 performs a control operation and a sensing operation related to sensing/non-sensing described in Operation examples 1 to 4 and notifies the sensing result illustrated in FIG. 14 and the capability illustrated in FIG. 16. That is, the sensing control unit 104 performs control so that sensing is not performed in a predetermined time region in the sensing time window. Moreover, the sensing control unit 104 performs control so that sensing is performed in the resources of the sensing pool and sensing is not performed in the non-sensing pool.

The resource selection unit 105 selects resources for transmitting D2D signals based on the sensing result obtained by the sensing control unit 104. In this example, resources which are not selected are determined using the threshold and the priority class described above, for example.

All of the configurations of the UE illustrated in FIG. 18 may be realized by a hardware circuit (for example, one or a plurality of IC chips), and portions thereof may be realized by a hardware circuit and the other may be realized by a CPU and a program.

FIG. 19 is a diagram illustrating an example of a hardware (HW) configuration of the UE. FIG. 19 illustrates a configuration more similar to an implementation example than FIG. 18. As illustrated in FIG. 19, the UE includes a RE (Radio Equipment) module 201 that performs processing on radio signals, a BB (Base Band) processing module 202 that performs baseband signal processing, a device control module 203 that performs processing of higher layers and the like, and a USIM slot 204 which is an interface that accesses a USIM card.

The RE module 201 generates radio signals to be transmitted from an antenna by performing D/A (Digital-to-Analog) conversion, modulation, frequency conversion, power amplification, and the like on the digital baseband signals received from the BB processing module 202. Moreover, the RE module 201 generates digital baseband signals by performing frequency conversion, A/D (Analog to Digital) conversion, demodulation, and the like on the received radio signals and delivers the generated digital baseband signals to the BB processing module 202. The RE module 201 includes the physical layer functions of the signal transmission unit 101 and the signal reception unit 102 illustrated in FIG. 18, for example.

The BB processing module 202 performs a process of converting an IP packet and a digital baseband signal or vice versa. A DSP (Digital Signal Processor) 212 is a processor that performs signal processing in the BB processing module 102. A memory 222 is used as a work area of the DSP 112. The BB processing module 202 includes the functions of higher layers than the physical layer of the signal transmission unit 101 and the signal reception unit 102 illustrated in FIG. 18, the resource management unit 103, the sensing control unit 104, and the resource selection unit 105, for example. All or some of the resource management unit 103, the sensing control unit 104, and the resource selection unit 105 may be included in the device control module 203.

The UE control module 203 performs protocol processing of the IP layer and processing of various applications. A processor 213 is a processor that performs the processing performed by the UE control module 203. A memory 223 is used as a work area of the processor 213. Moreover, the processor 213 reads and writes data from and to a USIM via a USIM slot 204.

<eNB>

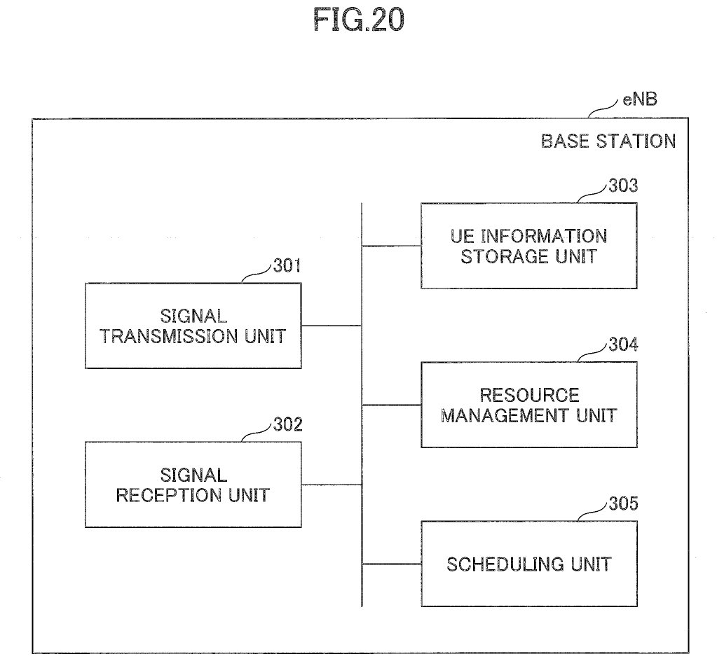

FIG. 20 illustrates a functional configuration of an eNB that performs the eNB-side operation described in the present embodiment. As illustrated in FIG. 20, the eNB includes a signal transmission unit 301, a signal reception unit 302, a UE information storage unit 303, a resource management unit 304, and a scheduling unit 305. FIG. 20 illustrates functional units of the eNB particularly related to the embodiment only and also includes at least functions (not illustrated) for operating as a base station in a mobile communication system compatible with LTE. Moreover, the functional configurations illustrated in FIG. 20 are examples only. The functional classifications and the names of the functional units are not particularly limited as long as the operations according to the present embodiment can be executed.

The signal transmission unit 301 includes a function of generating various signals of the physical layer from higher-layer signals to be transmitted from the eNB and transmitting the signals wirelessly. The signal reception unit 302 includes a function of wirelessly receiving various signals from the UE and acquiring higher-layer signals from the received physical layer signals.

The UE information storage unit 303 stores UE capability information received from each UE, a sensing result, and the like for each UE. The resource management unit 304 maintains information on a resource pool to be used for the UE to transmit and receive D2D signals and information (for example, a sensing time window, a sensing region, a non-sensing region, a sensing pool, a non-sensing pool, and the like) on resources related to sensing for each UE, for example. Moreover, various thresholds and various items of configuration information are maintained in the resource management unit 304 and are transmitted from the signal transmission unit 301 to the UE. Moreover, the scheduling unit 305 selects resources related to a subframe other than a congested sensing subframe based on the sensing result, for example, and executes an operation of allocating the resources to the UE.

All of the configurations of the eNB illustrated in FIG. 20 may be realized by a hardware circuit (for example, one or a plurality of IC chips), and portions thereof may be realized by a hardware circuit and the other may be realized by a CPU and a program.

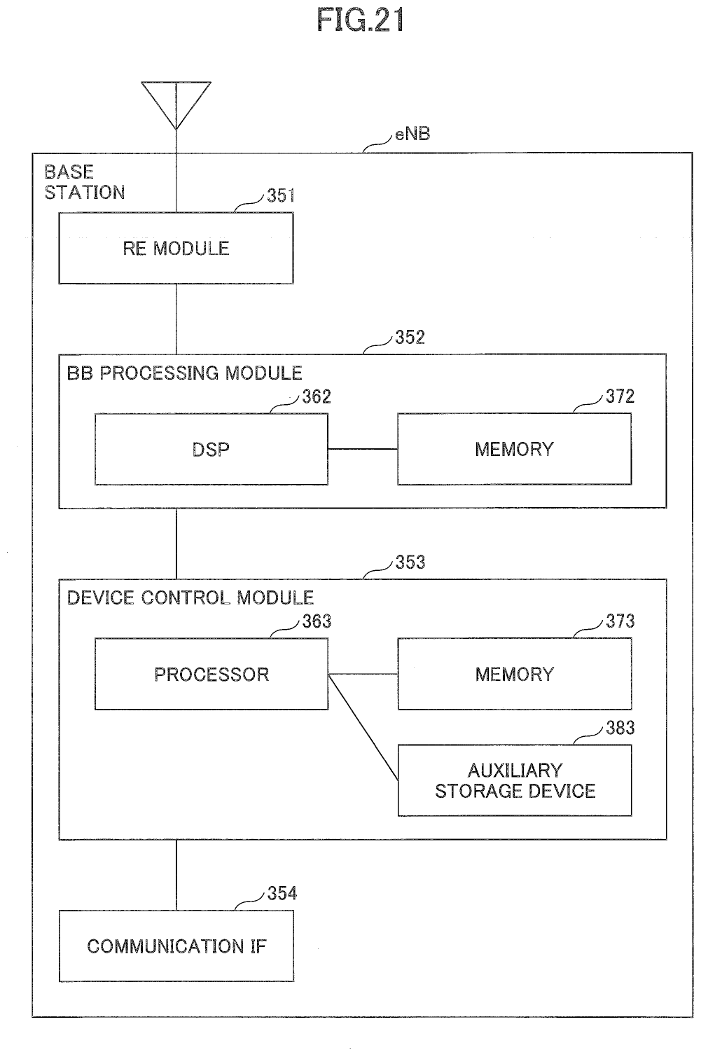

FIG. 21 is a diagram illustrating an example of a hardware (HW) configuration of the base station eNB. FIG. 21 illustrates a configuration more similar to an implementation example than FIG. 20. As illustrated in FIG. 20, the base station eNB includes a RE module 351 that performs processing on radio signals, a BB processing module 352 that performs baseband signal processing, a device control module 353 that performs processing of higher layers and the like, and a communication IF 354 which is an interface for connecting to a network.

The RE module 351 generates radio signals to be transmitted from an antenna by performing D/A conversion, modulation, frequency conversion, power amplification, and the like on the digital baseband signals received from the BB processing module 352. Moreover, the RE module 351 generates digital baseband signals by performing frequency conversion, A/D conversion, demodulation, and the like on the received radio signals and delivers the generated digital baseband signals to the BB processing module 352. The RE module 351 includes the physical layer functions of the signal transmission unit 301 and the signal reception unit 302 illustrated in FIG. 20, for example.

The BB processing module 352 performs a process of converting an IP packet and a digital baseband signal or vice versa. The DSP 362 is a processor that performs signal processing in the BB processing module 252. A memory 372 is used as a work area of the DSP 352. The BB processing module 352 includes the functions of higher layers than the physical layer of the signal transmission unit 301 and the signal reception unit 302 illustrated in FIG. 20, the UE information storage unit 303, the resource management unit 304, and the scheduling unit 305, for example. All or some of the UE information storage unit 303, the resource management unit 304, and the scheduling unit 305 may be included in the device control module 353.

The device control module 353 performs protocol processing of the IP layer, OAM processing, and the like. A processor 363 is a processor that performs the processing performed by the device control module 353. A memory 373 is used as a work area of the processor 363. An auxiliary storage device 383 is a HDD, for example, and stores various items of configuration information for the base station eNB itself to operate.

The configurations (functional classifications) of the devices illustrated in FIGS. 18 to 21 are examples of the configurations that realize the processes described in the present embodiment. The implementation method (specific arrangement, names, and the like of the functional units) are not particularly limited to a specific implementation method as long as the processes described in the present embodiment can be executed.

### SUMMARY OF EMBODIMENTS

As described above, according to the present embodiment, there is provided a user equipment that selects resources for transmitting signals based on a sensing result, including: a sensing control unit that performs control so that sensing is not performed in a predetermined time region in a sensing time window; a resource selection unit that selects resources for transmitting signals among resources in a time region in which sensing is performed in the time window; and a transmission unit that transmits signals using the resources selected by the resource selection unit.

According to this configuration, it is possible to reduce latency in a method in which a user equipment selects resources for transmitting signals based on a sensing result and improve the fairness in resource selection.

The predetermined time region is a time region corresponding to a timing at which signal transmission is performed, for example. Due to this configuration, it is possible to transmit signals in the sensing time window.

When the transmission unit performs cyclic signal transmission, the timing at which the signal transmission is performed may be a timing of the cyclic signal transmission, and the transmission unit may not perform signal transmission in a subsequent signal transmission timing. Since transmission is not performed in a timing corresponding to the time region in which sensing is not performed, it is possible to increase the chance for other user equipments to perform transmission.

The sensing control unit may set the predetermined time region in the time window as a non-sensing region autonomously or based on configuration information from a base station. In this manner, by setting the non-sensing region, it is possible to save the battery power, for example.

The transmission unit may report a sensing result obtained by the sensing control unit to a base station. Due to this configuration, the base station can use the sensing result in scheduling.

According to the present embodiment, there is provided a user equipment that selects resources for transmitting signals based on a sensing result, including: a reception unit that receives configuration information of a sensing pool which is a pool of resources in which sensing is performed and configuration information of a non-sensing pool which is a pool of resources in which sensing is not performed from a base station; a sensing control unit that performs sensing in resources of the sensing pool and performs control so that sensing is not performed in the non-sensing pool; a resource selection unit that selects resources for transmitting signals within the non-sensing pool; and a transmission unit that transmits signals using the resources selected by the resource selection unit.

According to this configuration, it is possible to reduce latency in a method in which a user equipment selects resources for transmitting signals based on a sensing result and improve the fairness in resource selection.

When a plurality of non-sensing pools is set to the user equipment, the resource selection unit may select a non-sensing pool which is closest to a signal transmission timing which occurs in a sensing pool and selects resources for transmitting signals within the non-sensing pool. Due to this configuration, it is possible to quickly transmit signals in the non-sensing pool.

The configurations of the UE described in the embodiment may be realized when a program is executed by a CPU (a processor) in the UE including the CPU and the memory. The configurations may be realized by hardware such as a hardware circuit that includes the logics of the processes described in the present embodiment and may be realized by a combination of a program and hardware.

The configurations of the eNB described in the embodiment may be realized when a program is executed by a CPU (a processor) in the eNB including the CPU and the memory. The configurations may be realized by hardware such as a hardware circuit that includes the logics of the processes described in the present embodiment and may be realized by a combination of a program and hardware.

While the embodiment of the present invention has been described, the disclosed invention is not limited to such an embodiment, and various variations, modifications, alterations, and substitutions could be conceived by those skilled in the art. While specific examples of numerical values are used in order to facilitate understanding of the invention, these numerical values are examples only and any other appropriate values may be used unless otherwise stated particularly. The classification of items in the description is not essential in the present invention, and features described in two or more items may be used in combination, and a feature described in a certain item may be applied to a feature described in another item (unless contradiction occurs). It is not always true that the boundaries of the functional units or the processing units in the functional block diagram correspond to boundaries of physical components. The operations of a plurality of functional units may be physically performed by a single component. Alternatively, the operations of the single functional unit may be physically performed by a plurality of components. The orders in the sequence and the flowchart described in the embodiment may be switched unless contradiction occurs. For convenience of explanation of processing, the UE and the eNB have been explained using functional block diagrams. However, these devices may be implemented by hardware, software, or a combination thereof. The software that operates by a processor included in the UE according to the embodiment of the present invention and the software that operates by a processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, and other appropriate storage media.

### Complement of Embodiments

Transmission of the information is not limited to the aspects/embodiments described in the invention, but may be performed by other methods. For example, transmission of the information may be performed by physical layer signaling (such as downlink control information (DCI) or uplink control information (UCI)), upper layer signaling (such as radio resource control (RRC) signaling, medium access control (MAC) signaling, broadcast information (such as a master information block (MIB) or a system information block (SIB)), other signaling, or a combination thereof. The RRC message may be referred to as RRC signaling. An RRC message may be, for example, an RRC connection setup message or an RRC connection reconfiguration message.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), or other appropriate systems and/or next-generation systems to which the systems are extended.

Judgment or determination may be performed using a value (0 or 1) indicated by one bit, may be performed using a Boolean value (true or false), or may be performed by comparison of numerical values (for example, comparison with a predetermined value).

The terms described in this specification and/or the terms required for understanding this specification may be substituted by terms having the same or similar meanings. For example, a channel and/or a symbol may be a signal. A signal may be a message.

The user equipment UE may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several appropriate terms by those skilled in the art.

The aspects/embodiments described in this specification may be used alone, may be used in combination, or may be switched with implementation thereof. Notification of predetermined information (for example, notification of “being X”) is not limited to explicit notification, but may be performed by implicit notification, for example, by not performing notification of predetermined information.

The terms “determining” and “determination” which are used in this specification may include various types of operations. The terms “determining” and “determination” may include that calculating, computing, processing, deriving, investigating, looking up (for example, looking up in a table, a database, or another data structure), and ascertaining are considered to be “determined.” The terms “determining” and “determination” may include that receiving (for example, receiving of information), transmitting (for example, transmitting of information), input, output, and accessing (for example, accessing data in a memory) are considered to be “determined.” The terms “determining” and “determination” may include that resolving, selecting, choosing, establishing, and comparing are considered to be “determined.” That is, the terms “determining” and “determination” can include that a certain operation is considered to be “determined.”

An expression “on the basis of ˜” which is used in this specification does not refer to only “on the basis of only ˜,” unless apparently described. In other words, the expression “on the basis of ˜” refers to both “on the basis of only ˜” and “on the basis of at least ˜.”

The processing sequences and the like of the aspects/embodiments described above in this specification may be changed in the order as long as they are not incompatible with each other. For example, in the methods described in this specification, various steps as elements are described in an exemplary order and the methods are not limited to the described order.

The input and output information or the like may be stored in a specific place (for example, a memory) or may be managed in a management table. The input and output information or the like may be overwritten, updated, or added. The output information or the like may be deleted. The input information or the like may be transmitted to another device.

Notification of predetermined information (for example, notification of “being X”) is not limited to explicit notification, but may be performed by implicit notification, for example, by not performing notification of the predetermined information.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

The invention is not limited to the above-mentioned embodiments and the invention includes various modifications, corrections, alternatives, and substitutions without departing from the concept of the invention.

This application claims priority from Japanese Patent Application No. 2016-073453, filed on Mar. 31, 2016, and the contents of Japanese Patent Application No. 2016-073453 are incorporated by reference herein in its entirety.

### EXPLANATIONS OF LETTERS OR NUMERALS

UE: User equipment
eNB: Base station
101: Signal transmission unit
102: Signal reception unit
103: Resource management unit
104: Sensing control unit
105: Resource selection unit
201: RE module
202: BB processing module
203: Device control module
204: USIM slot
301: Signal transmission unit
302: Signal reception unit
303: UE information storage unit
304: Scheduling unit
305: Scheduling unit
351: RE module
352: BB processing module
353: Device control module
354: Communication IF

1. A user equipment that selects resources for transmitting signals based on a sensing result, comprising:
a sensing control unit that performs control so that sensing is not performed in a predetermined time region in a sensing time window;
a resource selection unit that selects resources for transmitting signals among resources in a time region in which sensing is performed in the time window; and
a transmission unit that transmits signals using the resources selected by the resource selection unit.

2. The user equipment according to claim 1, wherein the predetermined time region is a time region corresponding to a timing at which signal transmission is performed.

3. The user equipment according to claim 2, wherein when the transmission unit performs cyclic signal transmission, the timing at which the signal transmission is performed is a timing of the cyclic signal transmission, and the transmission unit does not perform signal transmission in a subsequent signal transmission timing.

4. The user equipment according to claim 1, wherein the sensing control unit sets the predetermined time region in the time window as a non-sensing region autonomously or based on configuration information from a base station.

5. The user equipment according to claim 1, wherein the transmission unit reports a sensing result executed by the sensing control unit to a base station.

6. A user equipment that selects resources for transmitting signals based on a sensing result, comprising:
a reception unit that receives configuration information of a sensing pool which is a pool of resources in which sensing is performed and configuration information of a non-sensing pool which is a pool of resources in which sensing is not performed from a base station;
a sensing control unit that performs sensing in resources of the sensing pool and performs control so that sensing is not performed in the non-sensing pool;
a resource selection unit that selects resources for transmitting signals within the non-sensing pool; and
a transmission unit that transmits signals using the resources selected by the resource selection unit.

7. The user equipment according to claim 6, wherein when a plurality of non-sensing pools is set to the user equipment, the resource selection unit selects a non-sensing pool which is closest to a signal transmission timing which occurs in a sensing pool and selects resources for transmitting signals within the non-sensing pool.

8. A sensing control method executed by a user equipment that selects resources for transmitting signals based on a sensing result, comprising:
a sensing control step of performing control so that sensing is not performed in a predetermined time region in a sensing time window;
a resource selection step of selecting resources for transmitting signals among resources in a time region in which sensing is performed in the time window; and
a transmission step of transmitting signals using the resources selected in the resource selection step.

9. A sensing control method executed by a user equipment that selects resources for transmitting signals based on a sensing result, comprising:
a reception step of receiving configuration information of a sensing pool which is a pool of resources in which sensing is performed and configuration information of a non-sensing pool which is a pool of resources in which sensing is not performed from a base station;
a sensing control step of performing sensing in resources of the sensing pool and performing control so that sensing is not performed in the non-sensing pool;
a resource selection step of selecting resources for transmitting signals within the non-sensing pool; and
a transmission step of transmitting signals using the resources selected by the resource selection step.

10. The user equipment according to claim 2, wherein the transmission unit reports a sensing result executed by the sensing control unit to a base station.

11. The user equipment according to claim 3, wherein the transmission unit reports a sensing result executed by the sensing control unit to a base station.

12. The user equipment according to claim 4, wherein the transmission unit reports a sensing result executed by the sensing control unit to a base station.
